(19) United States
(12) Patent Application Publication
(10) Pub. No.: US 2016/0255334 A1
(43) Pub. Date: Sep. 1, 2016

(54) GENERATING AN IMPROVED DEPTH MAP USING A MULTI-APERTURE IMAGING SYSTEM

(71) Applicant: Dual Aperture International Co. Ltd., Seongnam-si (KR)

(72) Inventors: Andrew Augustine Wajs, Haarlem (NL); David D. Lee, Palo Alto, CA (US); Seungoh Ryu, Newton, MA (US); Taekun Woo, Yorba Linda, CA (US)

(21) Appl. No.: 14/949,736

(22) Filed: Nov. 23, 2015

Related U.S. Application Data
(60) Provisional application No. 62/121,182, filed on Feb. 26, 2015.

(51) Int. Cl. H04N 13/02

(52) U.S. Cl. CPC H04N 13/0271; H04N 13/0217; H04N 13/0214; H04N 13/0253; H04N 13/0257; H04N 2013/0081

(57) ABSTRACT

A multi-aperture imaging system determines depth map information. First raw image data associated with a first image of a scene is captured using a first imaging system characterized by a first point spread function (PSF). Second raw image data associated with a second image of the scene is captured using a second imaging system characterized by a second PSF that varies as a function of depth differently than the first point spread function. High-frequency image data is generated using the first raw image data and the second raw image data. Edges are identified using normalized derivative values of the high-frequency image data, and edge depth information is determined for the identified edges using a bank of blur kernels. Fill depth information is determined for image components other than the identified edges, and a depth map of the scene is generated using the edge depth information and the fill depth information.

### CROSS-REFERENCE TO RELATED APPLICATION(S)

This application claims priority under 35 U.S.C. §119(e) to U.S. Provisional Patent Application Ser. No. 62/121,182, “Depth Map For Dual-Aperture Camera,” filed on Feb. 26, 2015. The subject matter of all of the foregoing is incorporated herein by reference in their entirety.

### BACKGROUND

1. Field of the Invention

This disclosure relates generally to multi-aperture imaging and, more particularly, to generating depth maps using multi-aperture imaging.

2. Description of Related Art

The integration and miniaturization of digital camera technology put serious constraints onto the design of the optical system and the image sensor, thereby negatively influencing the image quality produced by the imaging system. Spacious mechanical focus and aperture setting mechanisms are not suitable for use in such integrated camera applications. Hence, various digital camera capturing and processing techniques are developed in order to enhance the imaging quality of imaging systems based on fixed focus lenses.

Although the use of a multi-aperture imaging system provides substantial advantages over known digital imaging systems, such system may not yet provide same functionality as provided in single-lens reflex cameras. In particular, it would be desirable to have a fixed-lens multi-aperture imaging system which allows adjustment of camera parameters such as adjustable depth of field and/or adjustment of the focus distance. Moreover, it would be desirable to provide such multi-aperture imaging systems with 3D imaging functionality similar to known 3D digital cameras. Additionally, as it can be computationally expensive to generate a large number of depth maps for a particular scene, the depth maps are often not available in real time using conventional 3D digital cameras. Hence, there is need in the art for methods and systems allowing which may provide multi-aperture imaging systems enhanced functionality.

### SUMMARY

A multi-aperture imaging system for calculating depth information from imaged scenes. The multi-aperture imaging system includes a first imaging system and a second imaging system. The first imaging system is characterized by a first point spread function and the second imaging system is characterized by a second point spread function that varies as a function of depth differently than the first point spread function. The first imaging system captures first raw image data associated with a first image of a scene, and the second imaging system captures second raw image data associated with a second image of the scene. In some embodiments, the first imaging system captures image data in the visible spectrum of light, and the second imaging system captures image data in the infrared spectrum of light.

The multi-aperture imaging system generates high-frequency image data using the first raw image data and the second raw image data. For example, the multi-aperture imaging system applies a high pass filter to some or all of the first raw image data and some or all of the second raw image data. The high-frequency image data corresponding to a rough location of edges of objects in the imaged scene.

The multi-aperture imaging system identifies the edges using normalized derivative values of the high-frequency image data. In some embodiments, the multi-aperture imaging system calculates derivative values of adjacent pixels located in the high-frequency image data, and then normalizes the magnitude and/or polarity of the derivate values. The normalized values correspond to locations of the edges.

The multi-aperture imaging system determines edge depth information for the identified edges. In some embodiments, the multi-aperture imaging system uses a bank of blur kernels and the identified edges to determine the edge depth information. A blur kernel is representative of an amount of blur that a point source undergoes at a particular band of wavelengths for a given distance to the multi-aperture imaging system. The band of wavelengths can range from a sub-band of a single color to the full spectrum of visible and invisible light (e.g., infrared). In some embodiments, a blur kernel may also represent an approximation of the blur through using a synthetic blur kernel (i.e., an idealized representation of the blur) as well as a measured blur kernel. The bank of blur kernels includes blur kernels over a range of distances and over a range of wavelengths (e.g., Red, Green, Blue, and Infrared). Edge depth information describes a distance from an edge of an object in the imaged scene to the multi-aperture imaging system. In some embodiments, the multi-aperture imaging system determines edge depth information by applying the blur kernels corresponding to the first imaging system and blur kernels corresponding to the second imaging system to areas on the identified edges. The multi-aperture imaging system then determines the depth information for the areas by determining which set of blur kernels (i.e., blur kernel from the first imaging system that is associated with a particular distance and a corresponding blur kernel from the second imaging system that is associated with the particular distance) results in a minimum difference for each of the areas on the identified edges. For a given area, the distance associated with the determined set of blur kernels is the edge depth information for the given area.

The multi-aperture system determines fill depth information for image components other than the identified edges. Fill depth information describes depth information for image components other than the identified edges. For example, fill depth information may describe depth information for a fill area between edges. Fill depth information may be determined using color-based regularization, time of flight analysis, structured light, or some combination thereof. In some embodiments, time of flight analysis or structured light may be used to determine both edge information and fill information.

Color-based regularization determines the fill depth information based on colors associated with the identified edge pixels. The multi-aperture imaging system identifies edge pixels whose color are within a threshold value of each other. The multi-aperture imaging system then identifies non-edge pixels adjacent to the identified edge pixels that have corresponding color values to the identified edge pixels, and assigns the edge depth information to the identified non-edge pixels. In some embodiments, the distance of the identified non-edge pixel from the identified edge pixel may also be used to weight the depth information being assigned to the non-edge pixel.

Time of flight analysis may also be used to determine fill depth information. The multi-aperture system includes an illumination source (e.g., IR Flash) that is configured to send pulses of light at specific times. The multi-aperture system determines the fill depth information based on a comparison between raw image data captured for each of the pulses. In some embodiments, two exposures are utilized to determine fill depth information. The first exposure has the IR flash fired at a specific time relative to the frame capture time. The second exposure is captured with a different timing relationship between the IR flash and the image capture. The shift in timing between the IR frame capture and the IR flash is such that the intensity of the IR image due to the flash is dependent on the distance of the object from the camera.

Structured light may also be used to determine fill depth information. The multi-aperture system includes an illumination source (e.g., IR) that is configured to project structured light onto the scene. The structured light acts to increase the spatial frequencies associated with portions of the scene that otherwise have relatively low spatial frequencies (e.g., a blank wall). Moreover, in some embodiments, the multi-aperture imaging system may interleave different types of image frames. For example, the first frame may be captured without using structured light or time of flight analysis, the second frame may be captured using structured light, the third frame may be captured using time of flight analysis, etc.

The multi-aperture imaging system generates a depth map of the scene using the edge depth information and the fill depth information. For example, the multi-aperture imaging system combines the edge depth information and the fill depth information to determine depth information for the imaged scene.

Other aspects include components, devices, systems, improvements, methods, processes, applications, computer readable mediums, and other technologies related to any of the above.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

Embodiments of the disclosure have other advantages and features which will be more readily apparent from the following detailed description and the appended claims, when taken in conjunction with the accompanying drawings, in which:

FIG. 1 is a block diagram of a multi-aperture, shared sensor imaging system according to one embodiment of the invention.

FIG. 2A is a graph illustrating the spectral responses of a digital camera.

FIG. 2B is a graph illustrating the spectral sensitivity of silicon.

FIGS. 3A-3C depict operation of a multi-aperture imaging system according to one embodiment of the invention.

FIG. 4 is a flow diagram of an image processing method for use with a multi-aperture imaging system according to one embodiment of the invention.

FIG. 5A is a graph of sharpness as a function of object distance.

FIG. 5B is a graph of sharpness ratio as a function of object distance.

FIG. 5C is a flow diagram of a method for generating a depth map according to one embodiment of the invention.

FIG. 6 is a diagram illustrating color transitions according to one embodiment of the invention.

FIG. 7 is a flow diagram of an image processing method including improved edge detection for use with the multi-aperture imaging system according to one embodiment of the invention.

FIG. 8 is a flow diagram of a process for generating fill depth information using structured light according to one embodiment of the invention.

FIG. 9 is a flow diagram of a process for generating fill depth information using time of flight analysis according to one embodiment of the invention.

FIG. 10 is an example of a scene being illuminated with structured light according to one embodiment of the invention.

FIG. 11A is an example image of a scene according to one embodiment of the invention.

FIG. 11B is an example image produced by regularization of the image in FIG. 11A, according to one embodiment of the invention.

FIG. 11C is an example of an image produced by color-based regularization of the image in FIG. 11A, according to one embodiment of the invention

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION OF THE PREFERRED EMBODIMENTS

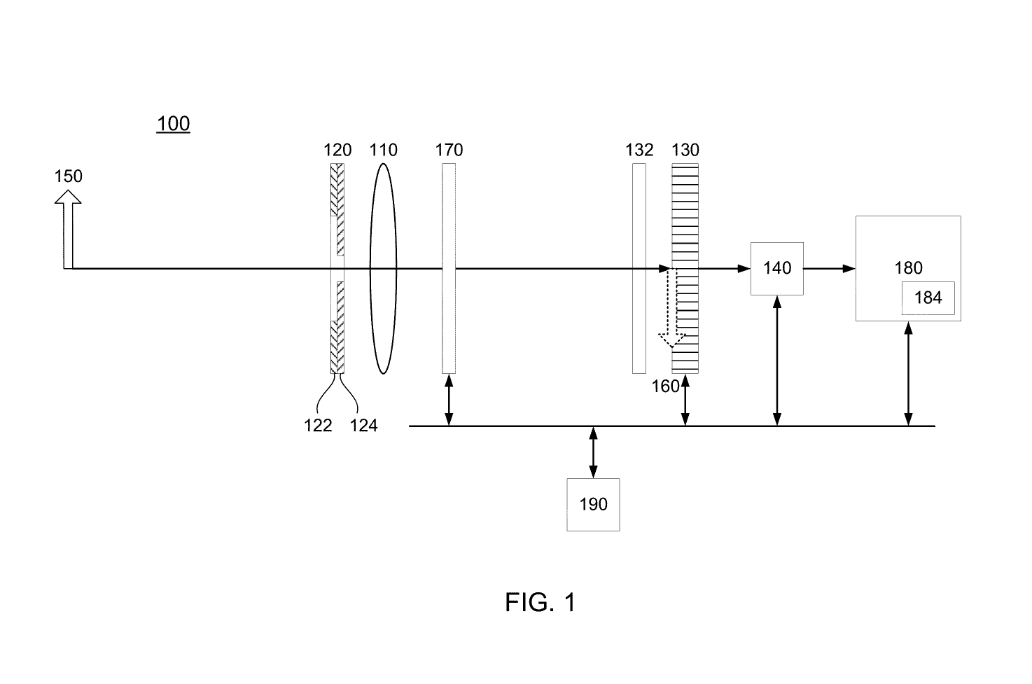

FIG. 1 is a block diagram of a multi-aperture, shared sensor imaging system 100, also referred to as a multi-aperture imaging system 100, according to one embodiment of the invention. The imaging system may be part of a digital camera or integrated in a mobile phone, a webcam, a biometric sensor, image scanner or any other multimedia device requiring image-capturing functionality. The system depicted in FIG. 1 includes imaging optics 110 (e.g., a lens and/or mirror system), a multi-aperture system 120 and an image sensor 130. The imaging optics 110 images objects 150 from a scene onto the image sensor. In FIG. 1, the object 150 is in focus, so that the corresponding image 160 is located at the plane of the sensor 130. As described below, this will not always be the case. Objects that are located at other depths will be out of focus at the image sensor 130.

The multi-aperture system 120 includes at least two apertures, shown in FIG. 1 as apertures 122 and 124. In this example, aperture 122 is the aperture that limits the propagation of visible light, and aperture 124 limits the propagation of infrared or other non-visible light. In this example, the two apertures 122, 124 are placed together but they could also be separated. This type of multi-aperture system 120 may be implemented by wavelength-selective optical components, such as wavelength filters. As used in this disclosure, terms such as “light” “optics” and “optical” are not meant to be limited to the visible part of the electromagnetic spectrum but to also include other parts of the electromagnetic spectrum where imaging may occur, including wavelengths that are shorter than visible (e.g., ultraviolet) and wavelengths that are longer than visible (e.g., infrared).

The sensor 130 detects both the visible image corresponding to aperture 122 and the infrared image corresponding to aperture 124. In effect, there are two imaging systems that share a single sensor array 130: a visible imaging system using optics 110, aperture 122 and sensor 130; and an infrared imaging system using optics 110, aperture 124 and sensor 130. The imaging optics 110 in this example is fully shared by the two imaging systems, but this is not required. In addition, the two imaging systems do not have to be visible and infrared. They could be other spectral combinations: red and green, or infrared and white (i.e., visible but without color), for example.

The exposure of the image sensor 130 to electromagnetic radiation is typically controlled by a shutter 170 and the apertures of the multi-aperture system 120. When the shutter 170 is opened, the aperture system controls the amount of light and the degree of collimation of the light exposing the image sensor 130. The shutter 170 may be a mechanical shutter or, alternatively, the shutter may be an electronic shutter integrated in the image sensor. The image sensor 130 typically includes rows and columns of photosensitive sites (pixels) forming a two dimensional pixel array. The image sensor may be a CMOS (complementary metal oxide semiconductor) active pixel sensor or a CCD (charge coupled device) image sensor. Alternatively, the image sensor may relate to other Si (e.g. a-Si), III-V (e.g. GaAs) or conductive polymer based image sensor structures.

When the light is projected by the imaging optics 110 onto the image sensor 130, each pixel produces an electrical signal, which is indicative of the electromagnetic radiation (energy) incident on that pixel. In order to obtain color information and to separate the color components of an image which is projected onto the imaging plane of the image sensor, typically a color filter array 132 is interposed between the imaging optics 110 and the image sensor 130. The color filter array 132 may be integrated with the image sensor 130 such that each pixel of the image sensor has a corresponding pixel filter. Each color filter is adapted to pass light of a predetermined color band onto the pixel. Usually a combination of red, green and blue (RGB) filters is used. However other filter schemes are also possible, e.g. CYGM (cyan, yellow, green, magenta), RGBE (red, green, blue, emerald), etc. Alternately, the image sensor may have a stacked design where red, green and blue sensor elements are stacked on top of each other rather than relying on individual pixel filters.

Each pixel of the exposed image sensor 130 produces an electrical signal proportional to the electromagnetic radiation passed through the color filter 132 associated with the pixel. The array of pixels thus generates image data (a frame) representing the spatial distribution of the electromagnetic energy (radiation) passed through the color filter array 132. The signals received from the pixels may be amplified using one or more on-chip amplifiers. In one embodiment, each color channel of the image sensor may be amplified using a separate amplifier, thereby allowing to separately control the ISO speed for different colors.

Further, pixel signals may be sampled, quantized and transformed into words of a digital format using one or more analog to digital (A/D) converters 140, which may be integrated on the chip of the image sensor 130. The digitized image data are processed by a processor 180, such as a digital signal processor (DSP) coupled to the image sensor, which is configured to perform well known signal processing functions such as interpolation, filtering, white balance, brightness correction, and/or data compression techniques (e.g. MPEG or JPEG type techniques).

The processor 180 may include signal processing functions 184 for obtaining depth information associated with an image captured by the multi-aperture imaging system. These signal processing functions may provide a multi-aperture imaging system with extended imaging functionality including variable depth of focus, focus control and stereoscopic 3D image viewing capabilities. The details and the advantages associated with these signal processing functions will be discussed hereunder in more detail.

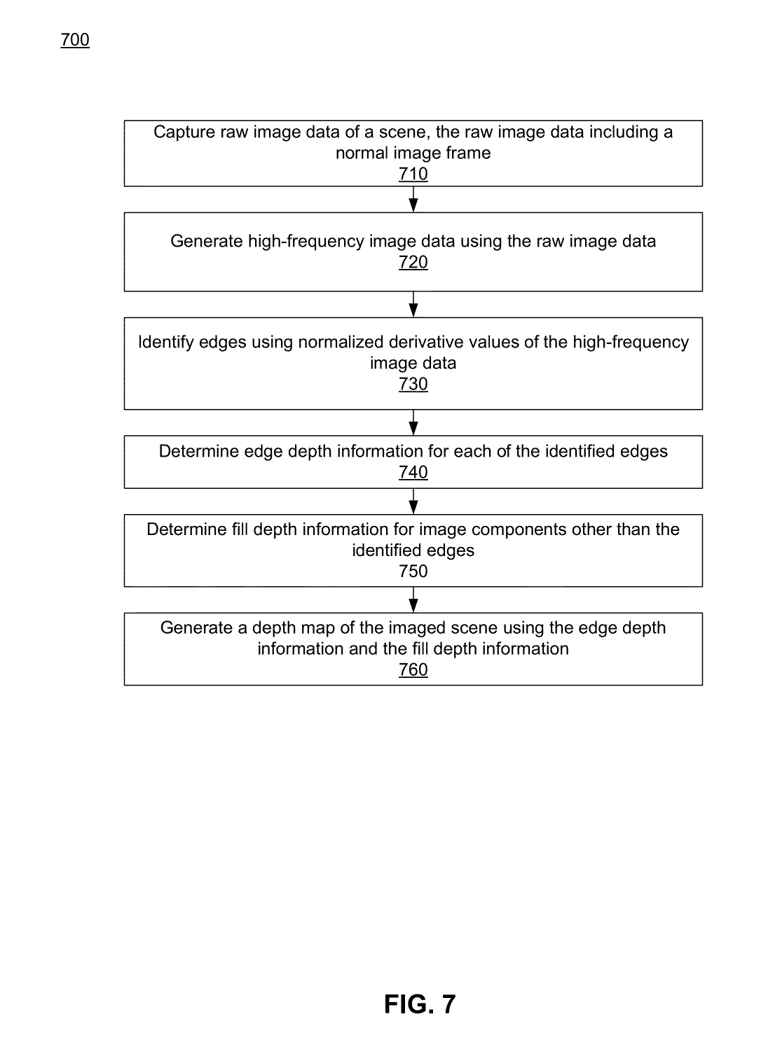

The processor 180 may also be coupled to additional compute resources, such as additional processors, storage memory for storing captured images and program memory for storing software programs. A controller 190 may also be used to control and coordinate operation of the components in imaging system 100. For example, the controller 190 may be configured to cause the multi-aperture imaging system 100 to perform the processes described below with regard to FIGS. 7-9. Functions described as performed by the processor 180 may instead be allocated among the processor 180, the controller 190 and additional compute resources.

As described above, the sensitivity of the multi-aperture imaging system 100 is extended by using infrared imaging functionality. To that end, the imaging optics 110 may be configured to allow both visible light and infrared light or at least part of the infrared spectrum to enter the imaging system. Filters located at the entrance aperture of the imaging optics 110 are configured to allow at least part of the infrared spectrum to enter the imaging system. In particular, imaging system 100 typically would not use infrared blocking filters, usually referred to as hot-mirror filters, which are used in conventional color imaging cameras for blocking infrared light from entering the camera. Hence, the light entering the multi-aperture imaging system may include both visible light and infrared light, thereby allowing extension of the photo-response of the image sensor to the infrared spectrum. In cases where the multi-aperture imaging system is based on spectral combinations other than visible and infrared, corresponding wavelength filters would be used.

In some embodiments, the multi-aperture imaging system 100 may also include one or more illumination sources (not shown). An illumination source is an IR light source that is used to illuminate a scene to assist the multi-aperture imaging system 100 in determining depth information for areas of low frequency (e.g., flat space on a wall). The illumination source may be, e.g., a structured light source, an IR flash, or some combination thereof.

A structured light source is configured, for a particular frame, to illuminate a scene with structured light. Structured light is light projected onto a scene that increases the spatial frequency of the illuminated surface. Structured light may be, e.g., dots, grids, horizontal bars, etc., or some combination thereof, that is projected out into the imaged scene. The structured light source includes an IR light source and a structured light element. The IR light source (e.g., laser diode, light emitting diode, etc.) emits IR light (e.g., 740 nm) toward the structured light element, which transforms the IR light into structured IR light. The structured light element is an optical element that when illuminated by a light source outputs structured light. The structured light element may be, e.g., a mask, a diffractive element, some other optical element that when illuminated by a light source outputs structured light, or some combination thereof. The multi-aperture imaging system 100 then projects (e.g., via one or more lenses) the structured IR light onto the scene.

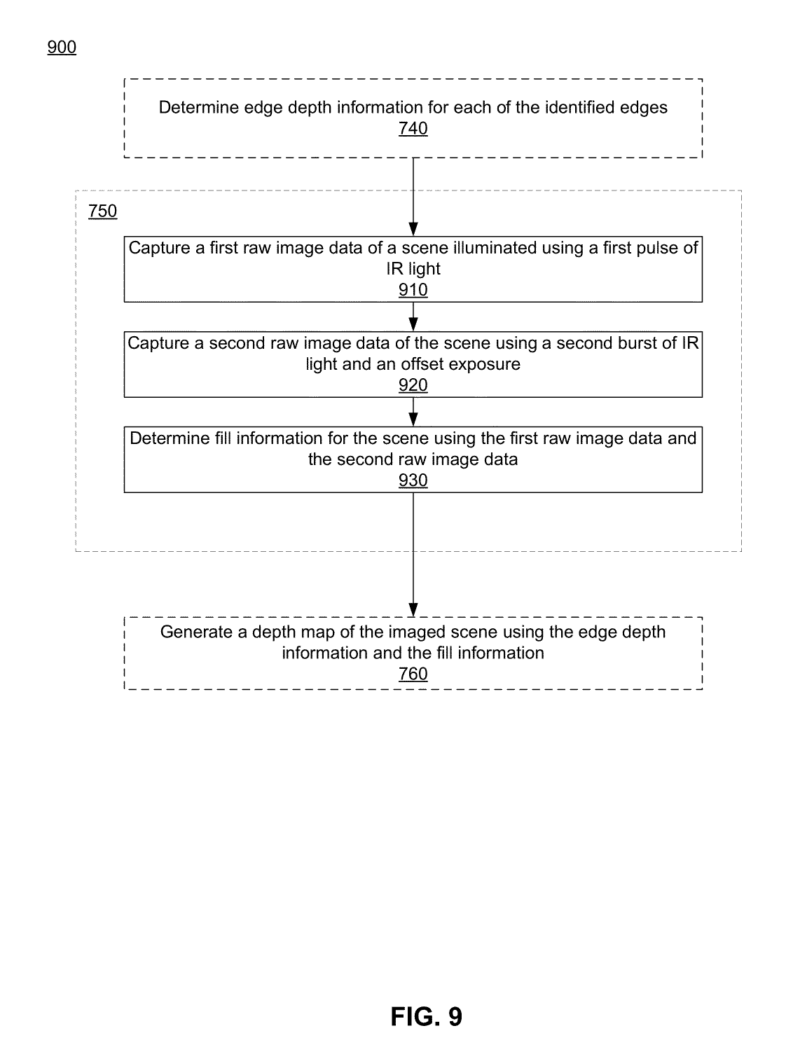

An IR flash is configured for use in time-of-flight analysis as discussed in detail below with regard to FIG. 9. The IR flash is configured to generate a flash of IR light of a particular pulse length. The IR flash may be, e.g., a laser diode, light emitting diode, or some other device capable of generating an IR flash of a specific pulse length.

The IR flash and/or the structured IR light are output at a specific narrow wavelength (e.g., 740 nm). In embodiments, the multi-aperture imaging system 100 includes a filter that has wide aperture in the visible portion of the electromagnetic spectrum (e.g., 400 nm to 700 nm) and a wide aperture that bounds the IR flash and/or structured IR light source wavelength (e.g., 730 nm-750 nm), but has a narrow aperture at other wavelengths (e.g., between 700 and 730 nm and over 750 nm). Moreover, in some embodiments, the IR flash and structured IR light may be at different wavelengths, and the filter may be configured to have wide apertures that bound each of those respective wavelengths.

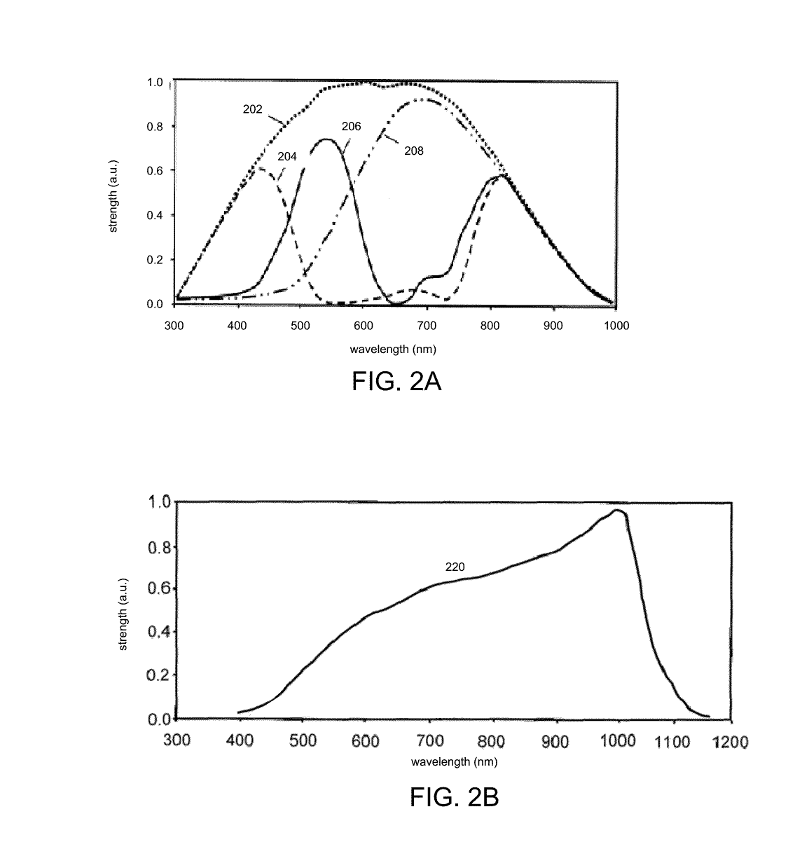

FIGS. 2A and 2B are graphs showing the spectral responses of a digital camera. In FIG. 2A, curve 202 represents a typical color response of a digital camera without an infrared blocking filter (hot mirror filter). As can be seen, some infrared light passes through the color pixel filters. FIG. 2A shows the photo-responses of a conventional blue pixel filter 204, green pixel filter 206 and red pixel filter 208. The color pixel filters, in particular the red pixel filter, may transmit infrared light so that a part of the pixel signal may be attributed to the infrared. FIG. 2B depicts the response 220 of silicon (i.e. the main semiconductor component of an image sensor used in digital cameras). The sensitivity of a silicon image sensor to infrared radiation is approximately four times higher than its sensitivity to visible light.

In order to take advantage of the spectral sensitivity provided by the image sensor as illustrated by FIGS. 2A and 2B, the image sensor 130 in the imaging system in FIG. 1 may be a conventional image sensor. In a conventional RGB sensor, the infrared light is mainly sensed by the red pixels. In that case, the DSP 180 may process the red pixel signals in order to extract the low-noise infrared information. This process will be described below in more detail. Alternatively, the image sensor may be especially configured for imaging at least part of the infrared spectrum. The image sensor may include, for example, one or more infrared (I) pixels in addition to the color pixels, thereby allowing the image sensor to produce a RGB color image and a relatively low-noise infrared image.

An infrared pixel may be realized by covering a pixel with a filter material, which substantially blocks visible light and substantially transmits infrared light, preferably infrared light within the range of approximately 700 through 1100 nm. The infrared transmissive pixel filter may be provided in an infrared/color filter array (ICFA) may be realized using well known filter materials having a high transmittance for wavelengths in the infrared band of the spectrum, for example a black polyimide material sold by Brewer Science under the trademark “DARC 400”.

Such filters are described in more detail in US2009/0159799, “Color infrared light sensor, camera and method for capturing images,” which is incorporated herein by reference. In one design, an ICFA contain blocks of pixels, e.g. a block of 2×2 pixels, where each block comprises a red, green, blue and infrared pixel. When exposed, such an ICFA image sensor produces a raw mosaic image that includes both RGB color information and infrared information. After processing the raw mosaic image, a RGB color image and an infrared image may be obtained. The sensitivity of such an ICFA image sensor to infrared light may be increased by increasing the number of infrared pixels in a block. In one configuration (not shown), the image sensor filter array uses blocks of sixteen pixels, with four color pixels (RGGB) and twelve infrared pixels.

Instead of an ICFA image sensor (where color pixels are implemented by using color filters for individual sensor pixels), in a different approach, the image sensor 130 may use an architecture where each photo-site includes a number of stacked photodiodes. Preferably, the stack contains four stacked photodiodes responsive to the primary colors RGB and infrared, respectively. These stacked photodiodes may be integrated into the silicon substrate of the image sensor.

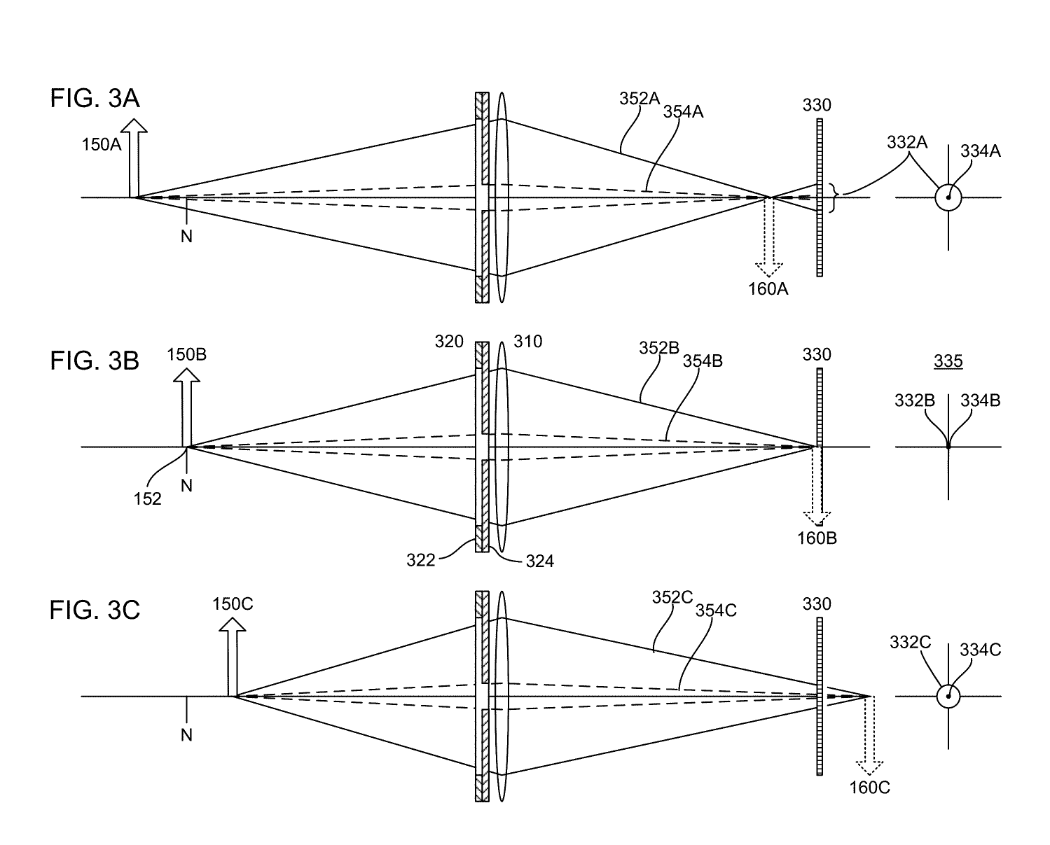

The multi-aperture system, e.g. a multi-aperture diaphragm, may be used to improve the depth of field (DOF) or other depth aspects of the camera. The DOF determines the range of distances from the camera that are in focus when the image is captured. Within this range the object is acceptably sharp. For moderate to large distances and a given image format, DOF is determined by the focal length of the imaging optics N, the f-number associated with the lens opening (the aperture), and/or the object-to-camera distance s. The wider the aperture (the more light received) the more limited the DOF. DOF aspects of a multi-aperture imaging system are illustrated in FIG. 3.

Consider first FIG. 3B, which shows the imaging of an object 150 onto the image sensor 330. Visible and infrared light may enter the imaging system via the multi-aperture system 320. In one embodiment, the multi-aperture system 320 may be a filter-coated transparent substrate. One filter coating 324 may have a central circular hole of diameter D1. The filter coating 324 transmits visible light and reflects and/or absorbs infrared light. An opaque cover 322 has a larger circular opening with a diameter D2. The cover 322 does not transmit either visible or infrared light. It may be a thin-film coating which reflects both infrared and visible light or, alternatively, the cover may be part of an opaque holder for holding and positioning the substrate in the optical system. This way, the multi-aperture system 320 acts as a circular aperture of diameter D2 for visible light and as a circular aperture of smaller diameter D1 for infrared light. The visible light system has a larger aperture and faster f-number than the infrared light system. Visible and infrared light passing the aperture system are projected by the imaging optics 310 onto the image sensor 330.

The pixels of the image sensor may thus receive a wider-aperture optical image signal 352B for visible light, overlaying a second narrower-aperture optical image signal 354B for infrared light. The wider-aperture visible image signal 352B will have a shorter DOF, while the narrower-aperture infrared image signal 354 will have a longer DOF. In FIG. 3B, the object 150B is located at the plane of focus N, so that the corresponding image 160B is in focus at the image sensor 330.

Objects 150 close to the plane of focus N of the lens are projected onto the image sensor plane 330 with relatively small defocus blur. Objects away from the plane of focus N are projected onto image planes that are in front of or behind the image sensor 330. Thus, the image captured by the image sensor 330 is blurred. Because the visible light 352B has a faster f-number than the infrared light 354B, the visible image will blur more quickly than the infrared image as the object 150 moves away from the plane of focus N. This is shown by FIGS. 3A and 3C and by the blur diagrams at the right of each figure.

Most of FIG. 3B shows the propagation of rays from object 150B to the image sensor 330. The righthand side of FIG. 3B also includes a blur diagram 335, which shows the blurs resulting from imaging of visible light and of infrared light from an on-axis point 152 of the object. In FIG. 3B, the on-axis point 152 produces a visible blur 332B that is relatively small and also produces an infrared blur 334B that is also relatively small. That is because, in FIG. 3B, the object is in focus.

FIGS. 3A and 3C show the effects of defocus. In FIG. 3A, the object 150A is located to one side of the nominal plane of focus N. As a result, the corresponding image 160A is formed at a location in front of the image sensor 330. The light travels the additional distance to the image sensor 330, thus producing larger blur spots than in FIG. 3B. Because the visible light 352A is a faster f-number, it diverges more quickly and produces a larger blur spot 332A. The infrared light 354 is a slower f-number, so it produces a blur spot 334A that is not much larger than in FIG. 3B. If the f-number is slow enough, the infrared blur spot may be assumed to be constant size across the range of depths that are of interest.

FIG. 3C shows the same effect, but in the opposite direction. Here, the object 150C produces an image 160C that would fall behind the image sensor 330. The image sensor 330 captures the light before it reaches the actual image plane, resulting in blurring. The visible blur spot 332C is larger due to the faster f-number. The infrared blur spot 334C grows more slowly with defocus, due to the slower f-number.

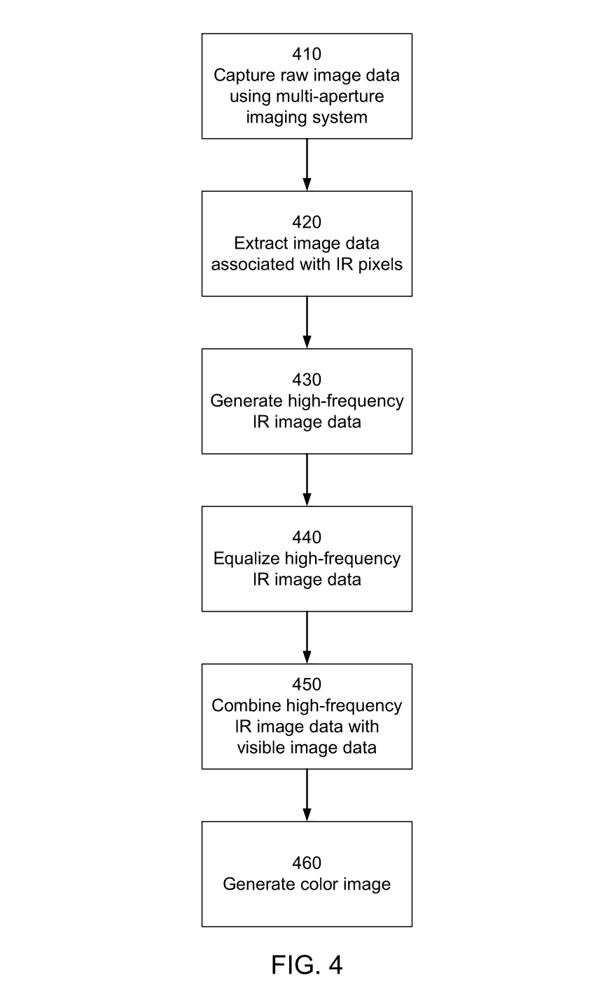

The DSP 180 may be configured to process the captured color and infrared images. FIG. 4 is a flow diagram of an image processing method for use with a multi-aperture imaging system according to one embodiment of the invention. In this example, the multi-aperture imaging system includes a conventional color image sensor using e.g. a Bayer color filter array. In that case, it is mainly the red pixel filters that transmit the infrared light to the image sensor. The red color pixel data of the captured image frame includes both a high-amplitude, sometimes blurry, visible red signal and a low-amplitude, always approximately in focus, infrared signal. Due to the wavelength characteristics of the Bayer color filter, the infrared component may be 8 to 16 times lower than the visible red component. Further, using known color balancing techniques, the red balance may be adjusted to compensate for the slight distortion created by the presence of infrared light. In other variants, an RGBI image sensor may be used, and the infrared image may be obtained directly from the I-pixels.

In FIG. 4, the multi-aperture imaging system captures 410 Bayer filtered raw image data. The DSP 180 extracts 420 the red color signal, which includes the infrared image data in addition to the red image data. The DSP extracts sharpness information associated with the infrared image from the red color signal and uses this sharpness information to enhance the color image. One way of extracting the sharpness information is by applying a high pass filter to the red image data. A high-pass filter retains the high frequency components within the red color signal while reducing the low frequency components. The kernel of the high pass filter may be designed to increase the brightness of the center pixel relative to neighboring pixels. The kernel array usually contains a single positive value at its centre, which is surrounded by negative values. An example of a 3×3 kernel for a high-pass filter is:

$$\begin{matrix}\vert - 1 / 9 & - 1 / 9 & - 1 / 9 \vert \\ \vert - 1 / 9 & 8 / 9 & - 1 / 9 \vert \\ \vert - 1 / 9 & - 1 / 9 & - 1 / 9 \vert\end{matrix}$$

The red color signal is passed through a high-pass filter 430 in order to extract the high-frequency components (i.e. the sharpness information) associated with the infrared image signal.

As the relatively small size of the infrared aperture produces a relatively small infrared image signal, the filtered high-frequency components are amplified 440 accordingly, for example in proportion to the ratio of the visible light aperture relative to the infrared aperture.

The effect of the relatively small size of the infrared aperture is partly compensated by the fact that the band of infrared light captured by the red pixel is approximately four times wider than the band of red light. Typically, a digital infrared camera is four times more sensitive than a visible light camera. After amplification, the amplified high-frequency components derived from the infrared image signal are added 450 to (or otherwise blended with) each color component of the Bayer filtered raw image data. This way, the sharpness information of the infrared image data is added to the color image. Thereafter, the combined image data may be transformed 460 into a full RGB color image using a demosaicking algorithm.

In a variant, the Bayer filtered raw image data are first demosaicked into a RGB color image and subsequently combined with the amplified high frequency components by addition or other blending.

The method shown in FIG. 4 allows the multi-aperture imaging system to have a wide aperture for effective operation in lower light situations, while at the same time to have a greater DOF resulting in sharper pictures. Further, the method effectively increase the optical performance of lenses, reducing the cost of a lens required to achieve the same performance.

The multi-aperture imaging system thus allows a simple mobile phone camera with a typical f-number of 2 (e.g. focal length of 3.5 mm and a diameter of 1.5 mm) to improve its DOF via a second aperture with a f-number varying e.g. between 6 for a diameter of 0.5 mm up to 15 or more for diameters equal to or less than 0.2 mm. The f-number is defined as the ratio of the focal length f and the effective diameter of the aperture. Preferable implementations include optical systems with an f-number for the visible aperture of approximately 2 to 4 for increasing the sharpness of near objects, in combination with an f-number for the infrared aperture of approximately 16 to 22 for increasing the sharpness of distance objects.

The improvements in the DOF and the ISO speed provided by a multi-aperture imaging system are described in more detail in U.S. application Ser. No. 13/144,499, “Improving the depth of field in an imaging system”; U.S. application Ser. No. 13/392,101, “Reducing noise in a color image”; U.S. application Ser. No. 13/579,568, “Processing multi-aperture image data”; U.S. application Ser. No. 13/579,569, “Processing multi-aperture image data”; and U.S. application Ser. No. 13/810,227, “Flash system for multi-aperture imaging.” All of the foregoing are incorporated by reference herein in their entirety.

The multi-aperture imaging system may also be used for generating depth information for the captured image. The DSP 180 of the multi-aperture imaging system may include at least one depth function, which typically depends on the parameters of the optical system and which in one embodiment may be determined in advance by the manufacturer and stored in the memory of the camera for use in digital image processing functions.

If the multi-aperture imaging system is adjustable (e.g., a zoom lens), then the depth function typically will also include the dependence on the adjustment. For example, a fixed lens camera may implement the depth function as a lookup table, and a zoom lens camera may have multiple lookup tables corresponding to different focal lengths, possibly interpolating between the lookup tables for intermediate focal lengths. Alternately, it may store a single lookup table for a specific focal length but use an algorithm to scale the lookup table for different focal lengths. A similar approach may be used for other types of adjustments, such as an adjustable aperture. In various embodiments, when determining the distance or change of distance of an object from the camera, a lookup table or a formula provides an estimate of the distance based on one or more of the following parameters: the blur kernel providing the best match between IR and RGB image data; the f-number or aperture size for the IR imaging; the f-number or aperture size for the RGB imaging; and the focal length. In some imaging systems, the physical aperture is constrained in size, so that as the focal length of the lens changes, the f-number changes. In this case, the diameter of the aperture remains unchanged but the f-number changes. The formula or lookup table could also take this effect into account.

In certain situations, it is desirable to control the relative size of the IR aperture and the RGB aperture. This may be desirable for various reasons. For example, adjusting the relative size of the two apertures may be used to compensate for different lighting conditions. In some cases, it may be desirable to turn off the multi-aperture aspect. As another example, different ratios may be preferable for different object depths, or focal lengths or accuracy requirements. Having the ability to adjust the ratio of IR to RGB provides an additional degree of freedom in these situations.

As described above in FIGS. 3A-3C, a scene may contain different objects located at different distances from the camera lens so that objects closer to the focal plane of the camera will be sharper than objects further away from the focal plane. A depth function may relate sharpness information for different objects located in different areas of the scene to the depth or distance of those objects from the camera. In one embodiment, a depth function R is based on the ratio of the sharpness of the color image components to the sharpness of the infrared image components.

In a first embodiment, a depth function R is defined by the ratio of the sharpness information in the color image to the sharpness information in the infrared image. Here, the sharpness parameter may relate to the circle of confusion, which corresponds to the blur spot diameter measured by the image sensor. As described above in FIGS. 3A-3C, the blur spot diameter representing the defocus blur is small (approaching zero) for objects that are in focus and grows larger when moving away to the foreground or background in object space. As long as the blur disk is smaller than the maximum acceptable circle of confusion, it is considered sufficiently sharp and part of the DOF range. From the known DOF formulas it follows that there is a direct relation between the depth of an object, e.g. its distance s from the camera, and the amount of blur or sharpness of the captured image of that object. Furthermore, this direct relation is different for the color image than it is for the infrared image, due to the difference in apertures and f-numbers.

Hence, in a multi-aperture imaging system, the increase or decrease in sharpness of the RGB components of a color image relative to the sharpness of the IR components in the infrared image is a function of the distance to the object. For example, if the lens is focused at 3 meters, the sharpness of both the RGB components and the IR components may be the same. In contrast, due to the small aperture used for the infrared image for objects at a distance of 1 meter, the sharpness of the RGB components may be significantly less than those of the infrared components. This dependence may be used to estimate the distances of objects from the camera.

In one approach, the imaging system is set to a large (“infinite”) focus point. That is, the imaging system is designed so that objects at infinity are in focus. This point is referred to as the hyperfocal distance H of the multi-aperture imaging system. The system may then determine the points in an image where the color and the infrared components are equally sharp. These points in the image correspond to objects that are in focus, which in this example means that they are located at a relatively large distance (typically the background) from the camera. For objects located away from the hyperfocal distance H (i.e., closer to the camera), the relative difference in sharpness between the infrared components and the color components will change as a function of the distance s between the object and the lens. The ratio between the sharpness information in the color image and the sharpness information in the infrared image, for an object at distance s, will hereafter be referred to as the sharpness ratio R(s).

The sharpness ratio R(s) may be obtained empirically by measuring the sharpness ratio for one or more test objects at different distances s from the camera lens. It may also be calculated based on models of the imaging system. In one embodiment, R(s) may be defined as the ratio between the absolute value of the high-frequency infrared components Dᵢᵣ and the absolute value of the high-frequency color components D_{col}, for an object located at distance s. In another embodiment, the depth function R(s) may be based on the difference between the infrared and color components.

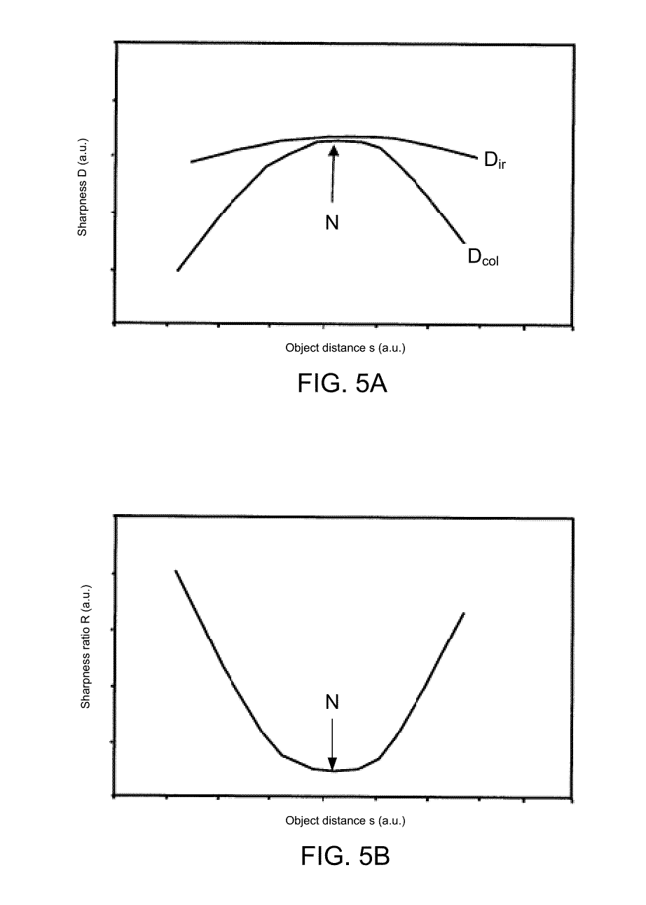

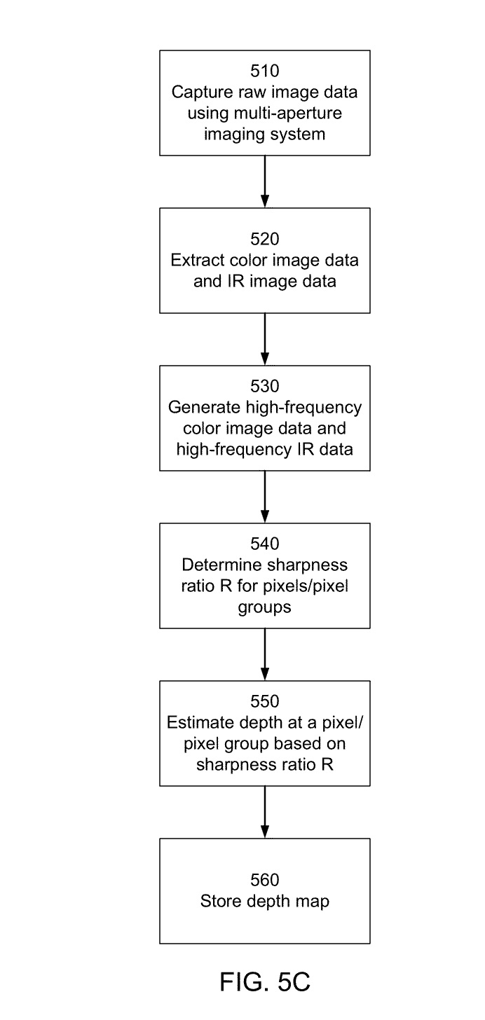

FIG. 5A is a plot of D_{col} and Dᵢᵣ as a function of object distance s, and FIG. 5B is a plot of the ratio R=Dᵢᵣ/D_{col} as a function of object distance s. FIG. 5A shows that around the focal distance N, the high-frequency color components have the highest values and that away from the focal distance N the high-frequency color components rapidly decrease as a result of blurring effects. Further, as a result of the relatively small infrared aperture, the high-frequency infrared components will not decrease as quickly as the high-frequency color components.

FIG. 5B shows the resulting depth function R defined as the ratio of Dᵢᵣ/D_{col}, indicating that for distances substantially larger than the focal distance N the sharpness information is included more in the high-frequency infrared image data. The depth function R(s) may be obtained by the manufacturer in advance and may be stored in the memory of the camera, where it may be used by the DSP in one or more post-processing functions for processing an image captured by the multi-aperture imaging system.

One example of post-processing is to generate a depth map for an image captured by the multi-aperture imaging system. FIG. 5C is a flow diagram of a method for generating a depth map according to one embodiment of the invention. The image sensor in the multi-aperture imaging system captures 510 both visible and infrared images. The DSP 180 separates 520 the color and infrared pixel signals in the captured raw mosaic image using e.g. a known demosaicking algorithm. The DSP uses a high-pass filter on the color image data (e.g. an RGB image) and the infrared image data in order to obtain 530 the high frequency components of both image data. Thereafter, the DSP determines a distance for each pixel (or group of pixels) p(i,j). To that end, the DSP may determine 540 for each pixel/group p(i,j) the sharpness ratio R(i,j) between the high frequency infrared components and the high frequency color components: R(i,j)=Dᵢᵣ(i,j)/D_{col}(i,j). On the basis of depth function R(s), in particular using the inverse depth function, the DSP may then convert 550 the measured sharpness ratio R(i,j) at each pixel to an object distance s(i,j) for that pixel. This process will generate a distance map where each distance value in the map is associated with a pixel in the image. The generated depth map may be stored 560 in a memory of the camera.

Examples of post-processing functions, including other variations for calculating sharpness and/or depth, are described in U.S. application Ser. No. 13/144,499, “Improving the depth of field in an imaging system”; U.S. application Ser. No. 13/392,101, “Reducing noise in a color image”; U.S. application Ser. No. 13/579,568, “Processing multi-aperture image data”; U.S. application Ser. No. 13/579,569, “Processing multi-aperture image data”; and U.S. application Ser. No. 13/810,227, “Flash system for multi-aperture imaging”; all of which are incorporated herein in their entirety. For example, in FIGS. 3A-3C, the visible and infrared apertures are centered with respect to each other. As a result, although the blur spots change in size as a function of distance to the object, the visible and infrared blur spots remain centered with respect to each other. If the apertures are instead offset from each other, then the blur spots can be designed so that they are also offset, with the amount of offset changing as a function of distance. This can then also be used to estimate the object distance. As another example, the infrared aperture may be composed of two or more small sub-apertures, for example a small circular aperture near the bottom of the visible aperture and another small circular aperture near the top of the visible aperture. Because this type of aperture produces two disjoint spots, depth information may be estimated based on autocorrelation of the high-pass filtered infrared image.

In some embodiments, depth information may be determined using a bank of blur kernels. A blur kernel is representative of an amount of blur that a point source undergoes at a particular band of wavelengths for a given distance to the multi-aperture imaging system 100. The band of wavelengths can range from a sub-band of a single color to the full spectrum of visible and invisible light (e.g., infrared). In some embodiments, a blur kernel may also represent an approximation of the blur through using a synthetic blur kernel (i.e., an idealized representation of the blur) as well as a measured blur kernel. The multi-aperture imaging system 100 includes a first imaging system and a second imaging system. For example, the first imaging system may correspond to the portion of the multi-aperture imaging system 100 that captures visible light, and the second imaging system may correspond to the portion of the multi-aperture imaging system 100 that captures IR light. The first imaging system is characterized by a first point spread function and the second imaging system is characterized by a second point spread function that varies as a function of depth differently than the first point spread function. The first imaging system captures first raw image data associated with a first image of a scene, and the second imaging system captures second raw image data associated with a second image of the scene.

The bank of blur kernels includes blur kernels over a range of distances and over a range of wavelengths for both the first and second imaging system. Blur kernels associated with the first imaging system are referred to as first blur kernels, and blur kernels associated with the second imaging system are referred to as second blur kernels. For example, assuming the first imaging system images light in the visible spectrum and the second imaging system images light in the IR spectrum, the first blur kernels include for each distance value a blur kernel for the blue channel, the red channel, the green channel, or some combination thereof. And the second blur kernels include for each of the distance values IR blur kernels. Accordingly, for a given distance value there is a set of blur kernels—at least one associated with the first imaging system and a second associated with the second imaging system. Additional information describing depth computations using blur kernels are described in U.S. application Ser. No. 14/832,062, titled “Multi-Aperture Depth Map Using Blur Kernels and Down Sampling,” filed on Aug. 21, 2015 and is hereby incorporated by reference in its entirety.

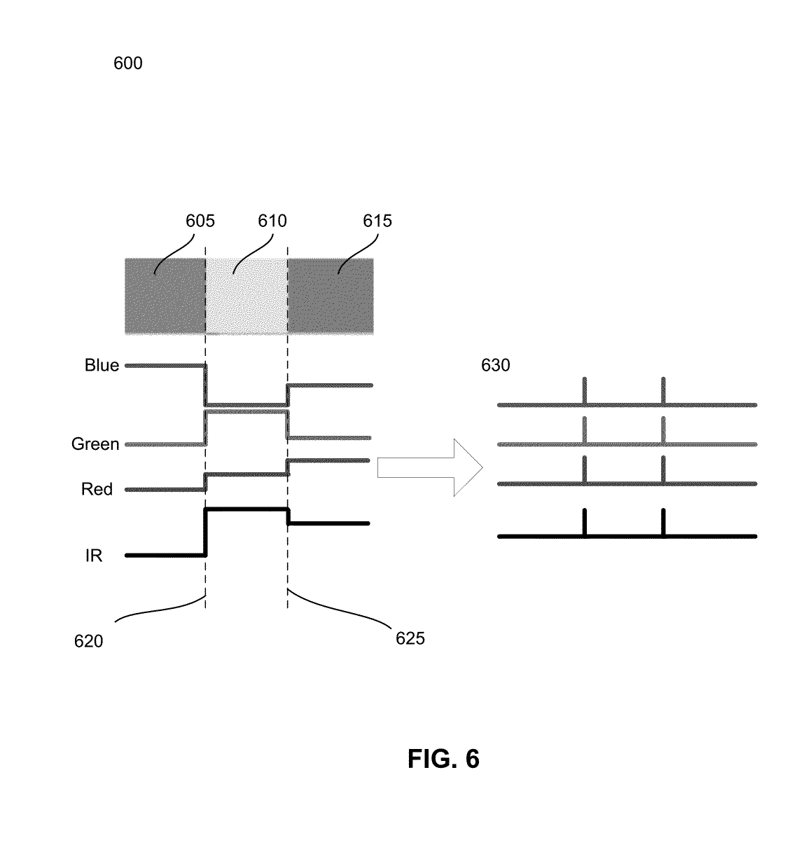

FIG. 6 is a diagram 600 illustrating color transitions according to one embodiment of the invention. The diagram 600 includes three adjacent color blocks, 605, 610, and 615, that are colored respectively blue, yellow, and grey. The diagram also includes a blue channel graph, a green channel graph, a red channel graph, and an infrared channel graph. Each of the transition graphs show the relative amplitude of a color channel of the multi-aperture imaging system 100 for the color blocks 605, 610, and 615. The color blocks 605 and 610 are separated by a transition boundary 620 and the color blocks 610 and 615 are separated by a transition boundary 625. The amplitude at a transition boundary (e.g., 620, 625) between two adjacent colors may result in different magnitudes and/or polarities in phases changes for different color channels (i.e., blue, green, red, and IR). For example, if there are two colors with the same green component but different levels of blue and red, there is no transition in the green channel but there are relatively large red and blue transitions. With regard to FIG. 6, in the IR there is a large amplitude change between blue and yellow—but a very small amplitude change between yellow and gray. Similarly, there is a large amplitude change between blue and yellow—but a small amplitude change between yellow and grey. Small changes in amplitude make it difficult to detect the changes in amplitude, and accordingly, can make it very difficult to detect transitions in color.

As discussed in detail below with regard to FIG. 7, in order to better detect transitions in color, the multi-aperture imaging system 100 is configured to determine the derivative of one or more of the color channels and/or the IR channel. At a transition boundary between two different colors this results in a negative or positive impulse, accordingly, for each of transition boundaries 620 and 625 there is an impulse for each of the different channels. The multi-aperture imaging system 100 then normalizes the output by making the impulses have the same amplitude and polarity. In the context of FIG. 7, the resulting output is shown in the output waveforms 630 for each of the channels. Note, that for each of the channels of the output waveforms 630 there are clear impulses that correspond to the positions of the transition boundaries 620 and 625. Accordingly, the output waveforms 630 remove the impact of possible differences in the different transitions for different colors.

FIG. 7 is a flow diagram of an image processing method 700 for generating depth information using improved edge detection and fill depth information for use with the multi-aperture imaging system 100 according to one embodiment of the invention. In one embodiment, the process of FIG. 7 is performed by the multi-aperture imaging system 100. Other entities may perform some or all of the steps of the process in other embodiments. Likewise, embodiments may include different and/or additional steps, or perform the steps in different orders.

The multi-aperture imaging system 100 captures 710 raw image data of a scene, the raw image data including a normal image frame. The normal image frame is an image frame of the scene that includes RGB channel information as well as IR channel information. The multi-aperture imaging system 100 may include two separate imaging pathways, specifically, a first imaging system characterized by a first point spread function and a second imaging system characterized by a second point spread function that varies as a function of depth differently than the first point spread function. The first imaging system captures first raw image data associated with a first image of a scene, and the second imaging system captures a second raw image data associated with a second image of the scene. For example, the first imaging system may capture an RGB image of the scene, and the second imaging system may capture an IR image of the scene. In some embodiments, the RGB image (e.g., the first image) and the IR image (e.g., the second image) are captured at the same time using the same sensor. The multi-aperture imaging system 100 separates the color and infrared pixel signals in the captured raw mosaic image using e.g. a known demosaicking algorithm.

The multi-aperture imaging system 100 generates 720 high-frequency image data using the raw image data. The multi-aperture imaging system 100 applies a high pass filter to the first image and the second image to generate high-frequency image data. In embodiments where the first image is a color image, and the second image is an IR image, high-frequency color image data is generated by applying a high pass filter to one or more of the color channels (e.g., red, green, or blue) of the first image, and the high-frequency IR image data is generated by applying a high pass filter to the IR channel information. An example of a high pass filter is discussed above with regard to FIG. 4. Conceptually, the high-frequency image data (e.g., the color image data and the high-frequency IR data) may be thought of as a rough approximation of edges (i.e., color transitions) in the imaged scene.

The multi-aperture imaging system 100 identifies 730 edges (i.e., transitions in color) using normalized derivative values of the high-frequency image data. In some embodiments, the multi-aperture imaging system 100 calculates the derivative of adjacent pixel values for pixels located in the high-frequency image data (e.g., high frequency color image data and the high-frequency IR data). Additionally, in alternate embodiments, the multi-aperture imaging system 110 calculates the derivative of the of adjacent pixel values for pixels outside of the high-frequency color image data and the high-frequency IR data. For example, the multi-aperture imaging system 110 may calculate derivative values for all of the pixels.

The multi-aperture imaging system 100 then normalizes the magnitude and polarity of the calculated derivatives to identify edges. For example, the multi-aperture imaging system 100 adjusts all of the calculated values such that they have the same sign and are greater than or equal to some threshold magnitude. As each of the values are associated with a particular location in the imaged scene, by adjusting the calculated values such that they all are greater than or equal to some threshold magnitude and have the same polarity allows the multi-aperture system 100 to better distinguish the location of the edges that were roughly identified by the high pass filter. The use of the normalized derivative values allows for precise location of transitions in color and the normalization helps the multi-aperture imaging system 100 identify amplitude changes that would otherwise be minimal and difficult to detect (e.g., yellow to gray in the IR).

The multi-aperture imaging system 100 determines 740 edge depth information for the identified edges. In some embodiments, the multi-aperture imaging system 100 determines the edge depth information for each of the identified edges using a bank of blur kernels. The bank of blur kernels includes first blur kernels associated with the first imaging system and corresponding second blur kernels associated with the second imaging system. Edge depth information describes a distance from an edge of an object in the imaged scene to the multi-aperture imaging system. Each of the identified edges corresponds to groups of pixels, also referred to as edge pixels. The groups of edge pixels represent edges of objects in the scene. A fill area is an area composed of non-edge pixels. For example, an edge of a blank wall may be represented by edge pixels, the fill area is the remaining portion of the wall.

The multi-aperture imaging system 100 retrieves a first set of blur kernels and the corresponding set of second blur kernels for a given distance value. The multi-aperture imaging system 100 applies the retrieved blur kernels to blur a group of edge pixels. For example, the multi-aperture imaging system 100 may apply the retrieved blur kernels to an entire frame and a comparison is made in a window around a pixel of interest of the group of edge pixels, and a similar process is applied each of the edge pixels as the pixel of interest changes. In other embodiments, the multi-aperture imaging system 100 applies a retrieved IR blur kernel to the IR high frequency data (which is generally sharper than the visible images). The multi-aperture imaging system 100 then determines an error value for the blurred group of pixels by e.g., determining a magnitude of a difference between the group of pixels blurred by a first blur kernel and the group of pixels blurred by a second blur kernel. The multi-aperture imaging system 100 repeats the above process on the same group of edge pixels for different sets of first and second blur kernels until a minimum error value is determined. The depth value corresponding to the set of blur kernels used to generate the minimum error value is then mapped to that group of edge pixels, and the multi-aperture imaging system 100 moves to a second group of edge pixels and repeats the above process to identify a depth for the second group of edge pixels, moves to a third group of edge pixels and repeats the above process to identify a depth for the third group of edge pixels, and so on. In this manner, the multi-aperture imaging system 100 determines depth information for the edges in the scene.

In embodiments where the first blur kernels correspond to red, green, or blue blur kernels and the second blur kernels correspond to IR blur kernels, the multi-aperture imaging system may perform the above process for one or more of the color channels in the first blur kernels (i.e., red blur kernels, green blur kernels, and blue kernels). The multi-aperture system 100 performs the above process using a one or more of the colors in the first kernel and the IR blur kernels. In some embodiments, a single color of the first blur kernels may be used with the IR blur kernels. The multi-aperture imaging system 100 may determine which color of the first blur kernels is used by, e.g., selecting the channel with the highest contrast. For example, the multi-aperture imaging system 100 measures the contrast over an entire frame for each channel, and then select the channel having the highest contrast. Alternatively, the multi-aperture imaging system 100 measures contrast within a specific window for each of the channels, and selects the channel having the highest contrast within the specific window. In some embodiments, the multi-aperture imaging system 100 performs the above process with each of the channels separately to identify edges. In some embodiments, a weighting can be used based on the contrast in the channel (higher contrast higher weighting) either locally or across the entire image. to make the edges all look the same with the blur being the main difference.

In some embodiments, the aperture imaging system 100 determines edge depth information for the identified edges in substantially the same manner as described above with regard to steps 540-560 in FIG. 5C.

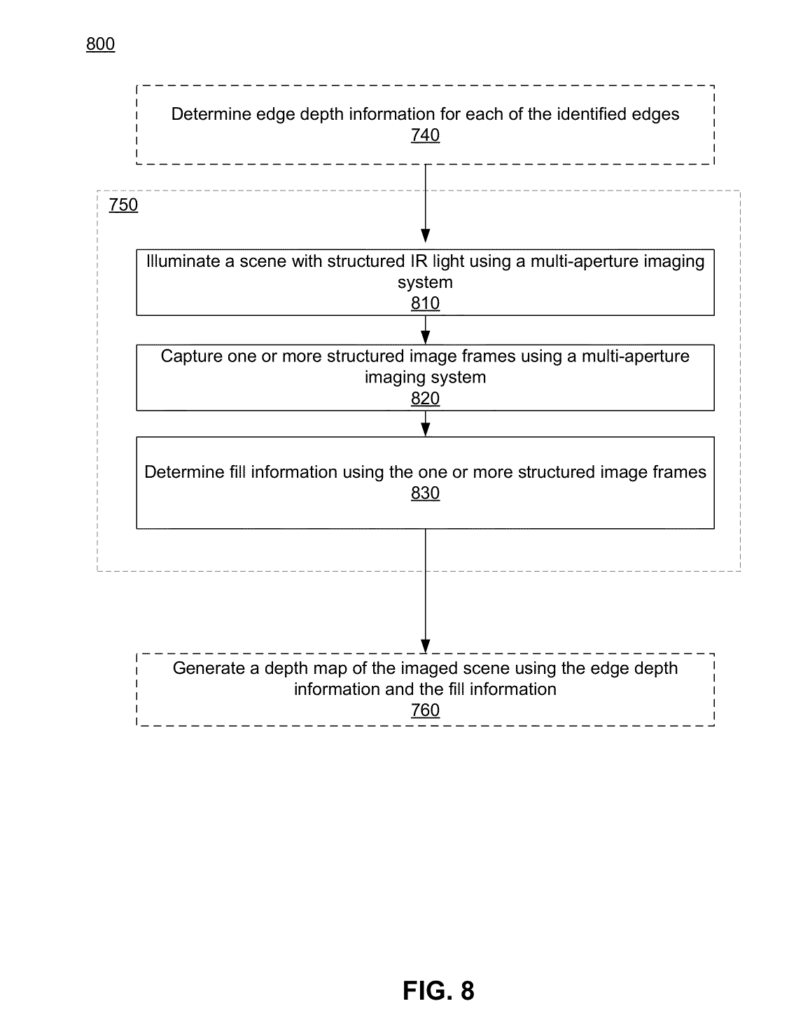

The multi-aperture imaging system 100 determines 750 fill depth information for image components other than the identified edges. For example, the multi-aperture imaging system 100 may determine the fill depth information for spaces between identified edges and/or other low frequency (frequency lower than the high-pass filter applied in step 720) portions of the imaged scene. Fill depth information may be determined using regularization, color based regularization, structured light, time of flight, or some combination thereof. The use of structured light to determine fill depth information is described in detail below with regard to FIG. 8, and the use of time of flight to determine structured light is described in detail below with regard to FIG. 9.

Regularization is one process of determining fill depth information. In some embodiments, regularization is based on edge information, but not color information. For example, an estimate of depth for a pixel of interest is based on taking a weighted average of depth values associated with edge pixels near the pixel of interest. The distance of an edge pixel to the pixel of interest is used to weight the edge pixel's contribution. Accordingly, the closer the edge pixel's position is to the pixel of interest, the greater the contribution it makes to the depth calculation. Accordingly, depth values may be calculated for pixels that are not associated with edges. The calculated depth values are referred to as fill depth information.

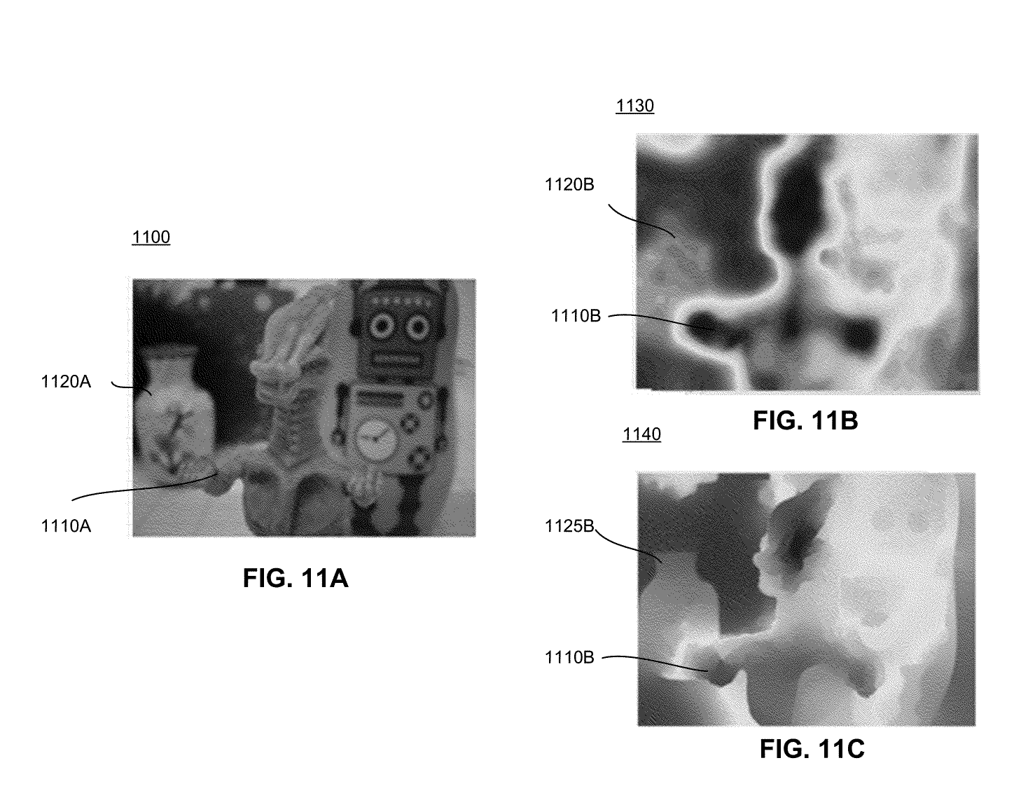

In other embodiments, color-based regularization is used to generate the fill depth information. Color-based regularization determines the fill depth information based on colors associated with the identified edge pixels. The multi-aperture imaging system 100 identifies edge pixels with relatively constant color values (e.g., color values of adjacent pixels are within a threshold range of values from each other). The identified edge pixels have known depth values (determined in step 740). The multi-aperture imaging system 100 then identifies non-edge pixels adjacent to the identified edge pixels that have corresponding color values to the identified edge pixels. The multi-aperture imaging system 100 then assigns the depth information associated with the identified edge pixels to the identified non-edge pixels. The multi-aperture imaging system 100 then iteratively identifies adjacent non-edge pixels that have corresponding color information and are adjacent to the previously identified non-edge pixels, and assigns the depth value to the identified pixels. In this manner, the multi-aperture imaging system 100 determines depth information for non-edge pixels by extrapolating a depth value for an edge across a surface with color that corresponds to the edge. Examples of regularization are discussed below with regard to FIG. 11.

The multi-aperture imaging system 100 generates 760 a depth map of the imaged scene using the edge depth information and the fill depth information. The edge depth information provides depth information for edges in the scene, and the fill depth information provides depth information for other portions of the scene (e.g., between identified edges, wall surfaces, etc.). The multi-aperture imaging system 100 combines the edge depth information and fill depth information into a single depth map for the imaged scene. In some embodiments, the multi-aperture imaging system 100 stores the depth map for later use and/or generates an image for presentation to the user of the multi-aperture imaging system 100.

Turning now to an embodiment of how fill depth information is generated in step 750, and specifically how it is generated using structured IR light, FIG. 8 is a flow diagram of a process 800 for generating fill depth information using structured IR light according an embodiment. In one embodiment, the process of FIG. 8 is performed by the multi-aperture imaging system 100. Other entities may perform some or all of the steps of the process in other embodiments. Likewise, embodiments may include different and/or additional steps, or perform the steps in different orders.

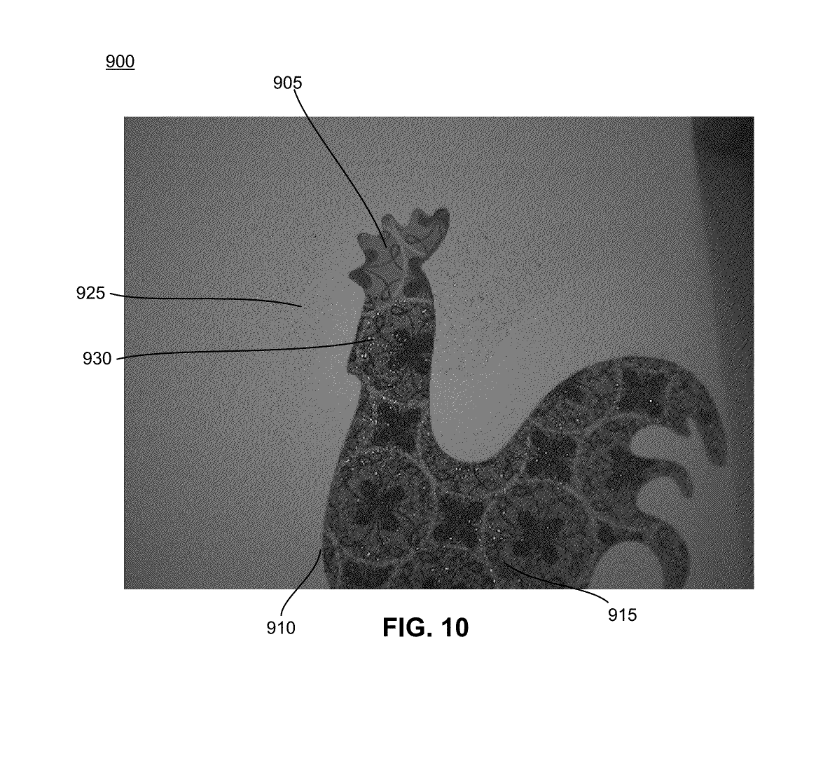

The system 100 illuminates 810 a scene with structured IR light using the multi-aperture imaging system 100. The structured IR light increases the spatial frequency associated with the illuminated portion of the scene. Accordingly, in performing step 720, high frequency image data is generated in areas illuminated by the structured IR light that otherwise might be filtered out by the high pass filter in step 720. In alternate embodiments, the structured IR light is a specific pattern that changes with distance from the multi-aperture imaging system 100 in a predictable manner. A structured depth model describes how the pattern changes with distance from the multi-aperture imaging system 100. An example of a scene illuminated with structured IR light is discussed below with regard to FIG. 10.

The multi-aperture imaging system 100 captures 820 one or more structured image frames. A structured image frame is an image frame that includes structured IR light (e.g., a normal image frame that includes structured IR light). In some embodiments, a single structured IR frame is captured. Alternatively, one or more normal image frames are captured for each structured IR frame. The ratio of normal image frames to structured IR frames may be adjusted for particular applications. For example, for an application where fine detail (i.e., depth varies relatively rapidly from pixel to pixel versus a situation where the depth is relatively constant across a surface) is essential, multiple normal image frames may be captured to track fine detail, while relatively few structured IR frames are captured to generate fill depth information for surfaces of relatively low resolution. While steps 810 and 820 are illustrated as occurring after step 740, in alternate embodiments, steps 810 and 820 occur in conjunction with step 710 or prior to step 710.

The multi-aperture imaging system 100 determines 830 fill depth information using the one or more structured image frames. In some embodiments, the multi-aperture imaging system 100 determines the fill depth information for portions of the imaged scene illuminated with the structured IR light using the same methodology described above for identifying edge depth information. For example, step 830 may include steps 720, 730, and 740. As the structured IR light increases the spatial resolution of the illuminated area, portions of the scene illuminated with the structured IR light are also included in the high frequency image data, and they can be considered pseudo edges—that edge depth information may be determined for in the same manner as described above in steps 730 and 740.

In alternate embodiments, the structured IR light is a known pattern that depth may be determined from by looking at changes in the pattern with distance from the multi-aperture imaging system 100. For each structured IR frame, the multi-aperture imaging system 100 identifies changes in the structured IR patterns within the structured IR image frame. For the identified changes in the structured IR patterns, the multi-aperture imaging system 100 determines a distance to the pattern using the structured depth model. For example, the multi-aperture imaging system 100 matches an identified structured IR pattern in the imaged scene to altered structured IR patterns in the structured depth model, where each of the known altered structured IR patterns are associated with different distance values from the multi-aperture system 100. Accordingly, the multi-aperture imaging system 100 is able to determine fill depth information for the identified structured IR patterns in the structured IR image frame. In alternate embodiments, the multi-aperture imaging system 100 calculates the depth information for the structured IR light using some other methodology. The process flow then proceeds to step 760 as described above.

Turning now to another embodiment of how fill depth information is generated in step 750, and specifically how it is generated using time of flight analysis. FIG. 9 is a flow diagram of a process 900 for generating fill depth information using time of flight analysis according to one embodiment of the invention. In one embodiment, the process of FIG. 9 is performed by the multi-aperture imaging system 100. Other entities may perform some or all of the steps of the process in other embodiments. Likewise, embodiments may include different and/or additional steps, or perform the steps in different orders.

The multi-aperture imaging system 100 captures 910 a first raw image data of a scene illuminated using a first pulse of IR light. Continuing the above example, the capturing of the first raw image is done by the second imaging system. The multi-aperture imaging system 100 controls the timing of the capture relative to the emission of the first pulse of IR light. The timing of the capture is controlled by an electronic shutter which may turn on/off the image sensor (e.g., image sensor 130) at specific times relative to sending a pulse of IR light. The pulse of IR light is of a fixed duration (Tₚᵤₗₛₑ) and starts at time, Tᵢₙᵢₜᵢₐₗ. The resulting IR light pulse illuminates the scene and some the IR light is reflected back toward the multi-aperture imaging system 100 by objects in the scene. Depending on the distance from the multi-aperture imaging system 100, the incoming light experiences a delay from Tᵢₙᵢₜᵢₐₗ. For example, an object 2.5 meters away will delay the light by 16.66 ns (=2*2.5 m/3*10̂6 m/s). In step 910 the electronic shutter opens at the same time the first pulse of IR light is sent, and stays open for a calibration period. The calibration period is a period of time sufficient to capture a threshold percentage of reflected IR pulse light. The calibration period is typically 2Tₚᵤₗₛₑ. In other embodiments, the calibration period may be some other value. Additionally, the calibration period may be configured to always be less than some threshold value. In alternate embodiments, in step 910 the electronic shutter opens at a time offset from a time the first pulse of IR light is sent.

The multi-aperture imaging system 100 captures 920 a second raw image data of the scene using a second pulse of IR light and an offset exposure. Continuing the above example, the capturing of the second raw image is done by the second imaging system. An offset exposure is when the IR pulse starts prior to the electronic shutter being open. For example, assuming an IR pulse starts at time 0, and lasts till time T, an offset exposure may start any time after time 0.

In some embodiments, the multi-aperture imaging system 100 or user selects the offset value based in part on a distance from an object within a zone of interest in the scene to the camera. Distance from the multi-aperture imaging system 100 may be divided up into a plurality of zones. Each zone corresponds to a different range of distances from the multi-aperture imaging system 100. For example, less than a meter from the multi-aperture imaging system 100, 1-3 meters from the multi-aperture imaging system 100, 3-6 meters from the multi-aperture imaging system 100, 6-10 meters from the multi-aperture imaging system 100, and greater than 10 meters from the multi-aperture imaging system 100 all may correspond to different zones. A zone of interest is a particular zone that is selected as being of interest. The offsets are different for objects in different zones of interest.

The multi-aperture imaging system 100 determines 930 fill depth information for the scene using the first raw image data and the second raw image data. The multi-aperture imaging system 100 matches the first frame of raw image data to the second frame of raw image data. The multi-aperture imaging system 100 uses the captured intensities between corresponding portions of the matched raw image data frames to calculate depth information. In some embodiments, the multi-aperture imaging system 100 determines the depth information for each corresponding pixel. In other embodiments, the multi-aperture imaging system 100 determines the depth information for pixels or groups of pixels that are not edges (e.g., as calculated in steps 720 and 730). The multi-aperture imaging system 100 determines the depth information for a particular portion of the first raw image data and corresponding portion of the second raw image data using the following relation:

Depth=0.5*c*Tₚᵤₗₛₑ*(Q₁/Q₁+Q₂) (1)

where c is the speed of light, Tₚᵤₗₛₑ is the IR pulse length, Q₁ is the accumulated charge from a pixel associated with the first raw image data, and Q₂ is the accumulated charge from a corresponding pixel associated with the second raw image data.

As the determined depth information includes depth information for non-edges—the process 900 is able to determine fill depth information. The process flow then proceeds to step 760 as described above.

In embodiments, using an IR illumination source, the multi-aperture imaging system 100 can interleave normal image frames with other image frames (e.g., structured image frame, IR flash, etc.). As the sensor frame rate increases, typically 30-60 frames per second to 120-240 frames per second, different lighting conditions can be applied to interleaved frames. In one example, (i) frames #1, #5, #9 . . . use normal lights; (ii) frames #2, #6, #10 . . . use normal lights and IR flash with specific spectrum (e.g. 650 nm-800 nm) to boost NIR exposure for IR diode particularly; (iii) frames #3, #7, #11 . . . use structured IR flash; and frames #4, #8, #12 . . . use visual flash to boost visual lights on RGB diodes. The first and fourth sets of frames are used for color image restoration and optimization; the second set of frames be used for estimating depth; and the third set of frames can be used for depth using structured lights (e.g., structured IR light). In other examples, other combinations of interleaved frames are used. Accordingly, interleaving normal image frames with other images frames may improve image quality and/or depth map estimation may be obtained.

FIG. 10 is an example of a scene 1000 being illuminated with structured light according to one embodiment of the invention. The scene 1000 includes an object 905 that is bounded by an edge 910 that surrounds a fill area 915. The scene 1000 is illuminated by structured light. Structured light reflected from the scene 1000 are the dots. For example, structured light may be seen on the background wall at 925, and on the object 905 at 930. Using, for example, the methods described above with respect to FIGS. 7 and 8, the multi-aperture imaging system 100 may determine the depth information for the scene 1000.

FIG. 11A is an example image 1100 of a scene according to one embodiment of the invention. The image 1100 includes a toy 1110A and a vase 1120A.

FIG. 11B is an example image 1130 produced by regularization of the image 1100 in FIG. 11A, according to one embodiment of the invention. The image 1130 is a pseudo color image showing depth information. The depth information generally maps from blue to red, with blue being assigned to portions of objects closest to the multi-aperture imaging system 100 and red being assigned to objects farthest from the multi-aperture imaging system 100.

FIG. 11C is an example image 1140 produced by color-based regularization of the image 1100 in FIG. 11A according to one embodiment of the invention. In the image 1140 the edges of the toy 1110C and the vase 1120C are much sharper than those in FIG. 11B. Similar to FIG. 11B, the image 1140 is in pseudo-color that is representative of depth information. One advantage to the color-based regularization is that the multi-aperture imaging system 100 is able to compute depth information much faster than using, e.g., regularization.

Turning now to a discussion of ways to improve computation speed of the multi-aperture imaging system 100. In some embodiments, the multi-aperture imaging system 100 (via, e.g., the controller 190) limits determining depth information to specific portions of the imaged scene instead of the entire scene. This selective determination of depth maps reduces the time it takes to ultimately generate a depth map for the imaged scene. In addition to standard imaging, this is also useful for gesture tracking applications.

In some embodiments, the multi-aperture imaging system 100 identifies pixels of interest from a plurality of sequential image frames. The image frames may be normal image frames (i.e., no structured light) or structured image frames. The multi-aperture imaging system 100 identifies the pixels of interest by identifying what regions are moving in the image frames. The multi-aperture imaging system 100 then generates a depth map for the identified regions using, e.g., steps 720-760 of FIG. 7.

In some embodiments, the multi-aperture imaging system 100 may also reduce possible delays in generation of depth maps by processing a depth map at certain intervals, such as every five frames, instead of every frame. The raw image data may be used directly to a gesture tracking module that provides gesture tracking functionality to the multi-aperture imaging system 100.

Turning now to a discussion of multi-stage depth resolution, the accuracy of depth measurement for the dual aperture camera may be dependent on (1) noise and (2) effective pixel size and resolution. As noise increases, the depth map becomes less accurate, however, with binning noise can be reduced. Effective pixel size and resolution is determined by the size of the pixel, the spacing between pixels and the amount of binning for the pixel. For example, the smaller the pixel size generally the more accurate the depth measurement. If pixels are skipped this has the effect of reducing the resolution of depth. For example, if every second pixel is skipped, the effective accuracy becomes restricted to the effective size of the actual and skipped pixel—i.e. reduced by a factor of 2. If the pixels are binned, the effective size of the pixel becomes the total size of the binned pixels.

This multi-stage approach has several benefits. The first benefit is that the number of filter comparisons is significantly reduced, and determining depth resolution takes less time. An additional benefit is that the better noise of the down-sampled version of the algorithm is used to constrain the algorithm as the images are up-sampled to ensure that the depth measurements are within the range determined by the lower noise image.

In some embodiments, once a depth map has been generated for an image scene, the depth map is used to filter out pixels in the imaged scene that are further away from the multi-aperture imaging system 100 and are not associated with the desired gesture. When the depth map is available, the multi-aperture imaging system 100 matches the depth map with the image frame to which it corresponds. The multi-aperture imaging system 100 analyzes the image frame to identify which objects are of interest. The optical flow is then used to track how these objects have moved through the subsequent frames to the current frame for which there is either no depth map available yet. The filtering is applied on the current frame.

Additionally, in some embodiments, the multi-aperture system 100 may take a sequence of image frames utilize different techniques to determine edge information and/or fill depth information. In some embodiments, the multi-aperture imaging system 100 may use e.g., the process of FIG. 5C to determine edge information for a first frame, and in subsequent frames use structured light and/or TOF analysis to determine depth information. Additionally, in some embodiments, an IR flash may fire that illuminates a scene with a structured light patter for a frame to determine partial depth information. Partial depth information is depth information that is augmented with depth information determined from another frame. An IR flash in a subsequent frame may be delayed relative to the IR flash in the previous frame—and TOF analysis may be used to determine partial depth information. The multi-aperture system determined the fill depth information using the partial depth information generated from the structured light and the partial depth information generated from the TOF analysis. The multi-aperture imaging system 100 generates a depth map of the scene using the edge depth information and the fill depth information.

It is to be understood that the above descriptions are only illustrative only, and numerous other embodiments can be devised without departing the spirit and scope of the embodiments.

Embodiments of the invention may be implemented as a program product for use with a computer system. The program(s) of the program product define functions of the embodiments (including the methods described herein) and can be contained on a variety of computer-readable storage media. Illustrative computer-readable storage media include, but are not limited to: (i) non-writable storage media (e.g., read-only memory devices within a computer such as CD-ROM disks readable by a CD-ROM drive, flash memory, ROM chips or any type of solid-state non-volatile semiconductor memory) on which information is permanently stored; and (ii) writable storage media (e.g., floppy disks within a diskette drive or hard-disk drive or any type of solid-state random-access semiconductor memory) on which alterable information is stored.

It is to be understood that any feature described in relation to any one embodiment may be used alone, or in combination with other features described, and may also be used in combination with one or more features of any other of the embodiments, or any combination of any other of the embodiments. Moreover, the invention is not limited to the embodiments described above, which may be varied within the scope of the accompanying claims. Moreover, the invention is not limited to the embodiments described above, which may be varied within the scope of the accompanying claims. For example, aspects of this technology have been described with respect to different f-number images captured by a multi-aperture imaging system. However, these approaches are not limited to multi-aperture imaging systems. They can also be used in other systems that estimate depth based on differences in blurring, regardless of whether a multi-aperture imaging system is used to capture the images. For example, two images may be captured in time sequence, but at different f-number settings. Another method is to capture two or more images of the same scene but with different focus settings, or to rely on differences in aberrations (e.g., chromatic aberrations) or other phenomenon that cause the blurring of the two or more images to vary differently as a function of depth so that these variations can be used to estimate the depth.

What is claimed is:

1. A method for generating depth information, the method comprising:
capturing first raw image data associated with a first image of a scene, the first raw image data captured using a first imaging system characterized by a first point spread function;
capturing second raw image data associated with a second image of the scene, the second raw image data captured using a second imaging system characterized by a second point spread function that varies as a function of depth differently than the first point spread function;
generating high-frequency image data using the first raw image data and the second raw image data;
identifying edges using normalized derivative values of the high-frequency image data;
determining edge depth information for the identified edges using a bank of blur kernels;
determining fill depth information for image components other than the identified edges; and
generating a depth map of the scene using the edge depth information and the fill depth information.

2. The method of claim 1, wherein the first imaging system has a first f-number and the second imaging system has a second f-number that is slower than the first f-number, whereby a size of the second point spread function varies as a function of depth more slowly than a size of the first point spread function.

3. The method of claim 2, further comprising:
exposing an image sensor in a multi-aperture sensor imaging system to light from the scene, using a first aperture with the first f-number to expose the first image and a second aperture with the second f-number to expose the second image.

4. The method of claim 3, wherein the first aperture exposes the first image using light from a visible spectrum, and the second aperture exposes the second image using light from an infrared spectrum.

5. The method of claim 4, wherein determining fill depth information for image components other than the identified edges comprises:
illuminating, via an infrared illumination source, the scene with structured light;
capturing raw image data corresponding to one or more image frames of the illuminated scene; and
determining the fill depth information using a structured depth model and the one or more image frames of the illuminated scene.

6. The method of claim 4, wherein the structured light increases the spatial frequency of at least one portion of the scene illuminated by the structured light.

7. The method of claim 4, wherein determining fill depth information for image components other than the identified edges comprises:
illuminating, via an infrared illumination source, the scene with a first pulse of infrared light and a subsequent second pulse of infrared light;
capturing first raw image data of the scene illuminated using the first pulse of infrared light;
capturing second raw image data of the scene illuminated using the second pulse of infrared light, wherein the second pulse of infrared light is offset from an electronic shutter associated with the image sensor; and
determining the fill depth information for the scene using the first raw image data and the second raw image data.

8. The method of claim 1, wherein determining fill depth information for image components other than the identified edges comprises:
identifying an edge pixel, in the identified edges, that has a color value that is all within a threshold range of color values;
identifying a non-edge pixel adjacent to the edge pixel, the non-edge pixel having a color value that is within the threshold range of values; and
extrapolating the edge depth information associated with the identified edge pixel to the identified non-edge pixel.

9. The method of claim 1, wherein identifying edges using normalized derivative values of the high-frequency image data comprises:
calculating derivative values of adjacent pixels located in the high-frequency image data; and
normalizing the magnitude and polarity of the derivative values, the normalized values being indicative of edges.

10. The method of claim 1, further comprising:
capturing a series of raw image data of the scene, the series of raw image data being representative of a series of image frames; and
determining that a region in at least two of the series of image frames is moving with respect to other regions in the at least two image frames,
wherein generating high-frequency image data using the first raw image data and the second raw image data, comprises:
applying a high pass filter to the first raw image data and the second raw image data to the identified region.

11. A non-transitory computer-readable storage medium storing executable computer program instructions for processing depth information, the instructions executable by a processor and causing the processor to perform a method comprising:
capturing first raw image data associated with a first image of a scene, the first raw image data captured using a first imaging system characterized by a first point spread function;
capturing second raw image data associated with a second image of the scene, the second raw image data captured using a second imaging system characterized by a second point spread function that varies as a function of depth differently than the first point spread function;
generating high-frequency image data using the first raw image data and the second raw image data;
identifying edges using normalized derivative values of the high-frequency image data;
determining edge depth information for the identified edges using a bank of blur kernels;
determining fill depth information for image components other than the identified edges; and
generating a depth map of the scene using the edge depth information and the fill depth information.

12. The computer readable medium of claim 11, wherein the first imaging system has a first f-number and the second imaging system has a second f-number that is slower than the first f-number, whereby a size of the second point spread function varies as a function of depth more slowly than a size of the first point spread function.

13. The computer readable medium of claim 12, further comprising:
exposing an image sensor in a multi-aperture sensor imaging system to light from the scene, using a first aperture with the first f-number to expose the first image and a second aperture with the second f-number to expose the second image.

14. The computer readable medium of claim 13, wherein the first aperture exposes the first image using light from a visible spectrum, and the second aperture exposes the second image using light from an infrared spectrum.

15. The computer readable medium of claim 14, wherein determining fill depth information for image components other than the identified edges comprises:
illuminating, via an infrared illumination source, the scene with structured light;
capturing raw image data corresponding to one or more image frames of the illuminated scene; and
determining the fill depth information using a structured depth model and the one or more image frames of the illuminated scene.

16. The computer readable medium of claim 14, wherein the structured light increases the spatial frequency of at least one portion of the scene illuminated by the structured light.

17. The computer readable medium of claim 14, wherein determining fill depth information for image components other than the identified edges comprises:
illuminating, via an infrared illumination source, the scene with a first pulse of infrared light and a subsequent second pulse of infrared light;
capturing first raw image data of the scene illuminated using the first pulse of infrared light;
capturing second raw image data of the scene illuminated using the second pulse of infrared light, wherein the second pulse of infrared light is offset from an electronic shutter associated with the image sensor; and
determining the fill depth information for the scene using the first raw image data and the second raw image data.

18. The computer readable medium of claim 11, wherein determining fill depth information for image components other than the identified edges comprises:
identifying an edge pixel, in the identified edges, that has a color value that is all within a threshold range of color values;
identifying a non-edge pixel adjacent to the edge pixel, the non-edge pixel having a color value that is within the threshold range of values; and
extrapolating the edge depth information associated with the identified edge pixel to the identified non-edge pixel.

19. The computer readable medium of claim 11, wherein identifying edges using normalized derivative values of the high-frequency image data comprises:
calculating derivative values of adjacent pixels located in the high-frequency image data; and
normalizing the magnitude and polarity of the derivative values, the normalized values being indicative of edges.

20. A method for generating depth information, the method comprising:
capturing a series of raw image data of a scene, the series of raw image data being representative of a series of image frames, the series of raw image data including:
a first raw image data associated with a first image of the scene, the first raw image data captured using a first imaging system characterized by a first point spread function, and
a second raw image data associated with a second image of the scene, the second raw image data captured using a second imaging system characterized by a second point spread function that varies as a function of depth differently than the first point spread function;
determining that a region in at least two of the series of image frames is moving with respect to other regions in the at least two image frames,
generating high-frequency image data using the first raw image data and the second raw image data using a high pass filter on the identified region;
identifying edges using normalized derivative values of the high-frequency image data; and
determining edge depth information the identified edges using a bank of blur kernels.

21. The method of claim 20, further comprising:
determining fill depth information for image components other than the identified edges; and
generating a depth map of the scene using the edge depth information and the fill depth information.

22. A method for generating depth information, the method comprising:
capturing first raw image data associated with a first image of a scene, the first raw image data captured using a first imaging system characterized by a first point spread function;
capturing second raw image data associated with a second image of the scene, the second raw image data captured using a second imaging system characterized by a second point spread function that varies as a function of depth differently than the first point spread function, the first imaging system and the second imaging system using the same detector and the first raw image data and the second raw image data captured as part of a first frame;
generating high-frequency image data using the first raw image data and the second raw image data;
identifying edges using normalized derivative values of the high-frequency image data;
determining edge depth information for the identified edges using a bank of blur kernels;
illuminating, via an infrared illumination source, the scene with a first infrared pulse of structured light;
capturing third raw image data corresponding a second frame of the illuminated scene;
determining a first partial fill depth information using a structured depth model and the third raw image data of the illuminated scene;
illuminating, via the infrared illumination source, the scene with a second infrared pulse of light;
capturing fourth raw image data of the scene illuminated using the first pulse of infrared light as part of a third image frame, wherein the second pulse of infrared light is offset from an electronic shutter associated with the image sensor;
determining a second partial fill depth information for the scene using the first raw image data and the second raw image data;
determining fill depth information using the first partial depth information and the second partial depth information; and
generating a depth map of the scene using the edge depth information and the fill depth information.
